(19) United States
(12) Patent Application Publication
(10) Pub. No.: US 2014/0044356 A1
(43) Pub. Date: Feb. 13, 2014

(54) ARRANGEMENT FOR AND METHOD OF READING SYMBOL TARGETS AND FORM TARGETS BY IMAGE CAPTURE

(71) Applicant: Duanfeng He, South Setauket, NY (US)

(72) Inventor: Duanfeng He, South Setauket, NY (US)

(73) Assignee: Symbol Technologies, Inc., Schaumburg, IL (US)

(21) Appl. No.: 13/568,264

(22) Filed: Aug. 7, 2012

(51) Int. Cl. G06K 9/20; G06K 9/00

(52) U.S. Cl. 382/182; 382/321

(57) ABSTRACT

An arrangement for, and a method of, electro-optically reading different types of targets by image capture, include an imaging assembly for capturing an image of a target over a field of view, and a controller for automatically distinguishing between the different types of targets, for decoding a symbol if the target being imaged is a symbol target, and for identifying and processing individual fields on a form if the target being imaged is a form target.

### FIELD OF THE DISCLOSURE

The present disclosure relates generally to an arrangement for, and a method of, electro-optically reading different types of targets by image capture, by automatically distinguishing between the different types of targets, by decoding a symbol if the target being imaged is a symbol target, and by identifying and processing individual fields on a form if the target being imaged is a form target.

### BACKGROUND

Solid-state imaging systems or imaging readers have been used, in both handheld and/or hands-free modes of operation, to electro-optically read symbol targets, each including one or more one- and/or two-dimensional bar code symbols, each bearing elements, e.g., bars and spaces, of different widths and reflectivities, to be decoded, as well as form targets, such as documents, labels, receipts, signatures, drivers' licenses, identification badges, and payment/loyalty cards, each bearing one or more data fields, typically containing alphanumeric characters, to be imaged. Some form targets may even include one or more one- or two-dimensional bar code symbols.

A known exemplary imaging reader includes a housing either held by a user and/or supported on a support surface, a window supported by the housing and aimed at the target, and an imaging engine or module supported by the housing and having a solid-state imager (or image sensor) with a sensor array of photocells or light sensors (also known as pixels), and an imaging lens assembly for capturing return light scattered and/or reflected from the target being imaged along an imaging axis through the window over a field of view, and for projecting the return light onto the sensor array to initiate capture of an image of the target over a range of working distances in which the target can be read. Such an imager may include a one- or two-dimensional charge coupled device (CCD) or a complementary metal oxide semiconductor (CMOS) device and associated circuits for producing and processing electrical signals corresponding to a one- or two-dimensional array of pixel data over the field of view. These electrical signals are decoded and/or processed by a programmed microprocessor or controller into information related to the target being read, e.g., decoded data indicative of a symbol, or into a picture of a form target. A trigger is typically manually activated by the user to initiate reading. Sometimes, an object sensing assembly is employed to automatically initiate reading whenever a target enters the field of view.

In the hands-free mode, the user may slide or swipe the target past the window in either horizontal and/or vertical and/or diagonal directions in a “swipe” mode. Alternatively, the user may present the target to an approximate central region of the window in a “presentation” mode. The choice depends on the type of target, operator preference, or on the layout of a workstation in which the reader is used. In the handheld mode, the user holds the reader in his or her hand at a certain distance from the target to be imaged and initially aims the reader at the target. The user may first lift the reader from a countertop or a support stand or cradle. Once reading is completed, the user may return the reader to the countertop or to the support stand to resume hands-free operation.

Although the known imaging readers are generally satisfactory for their intended purpose, one concern relates to reading different types of targets during a reading session. In a typical reading session, a majority of the targets are symbol targets, and a minority of the targets are form targets. The known imaging readers require that the user must configure the reader to read a form target prior to trigger activation. This configuring is typically done by having the user scan one or more configuration bar code symbols with the imaging reader during a calibration mode of operation, or by interacting the imaging reader with a host computer interface in which a host computer instructs the imaging reader to change its configuration, such that the microprocessor is taught to recognize a certain form target. However, this advance configuring is a cumbersome process and requires the user to remember to select, and to switch to, the correct form target prior to trigger activation.

Accordingly, there is a need to provide an arrangement for, and a method of, electro-optically reading different types of targets by image capture, by automatically distinguishing between the different types of targets, to enable the transition from reading between symbols and forms to be performed seamlessly and in a streamlined fashion.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an imaging reader operative in a hands-free mode for capturing images from targets to be electro-optically read.

FIG. 2 is a perspective view of another imaging reader operative in either a hand-held mode, or a hands-free mode, for capturing images from targets to be electro-optically read.

FIG. 3 is a perspective view of still another imaging reader operative in either a hand-held mode, or a hands-free mode, for capturing images from targets to be electro-optically read.

FIG. 4 is a schematic diagram of various components of the reader of FIG. 1 in accordance with the present invention.

FIG. 5 is a flow chart depicting operation of a method in accordance with the present invention.

FIG. 6 is a screen shot depicting steps performed during identification of different fields in a form target in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One feature of this invention resides, briefly stated, in an arrangement for electro-optically reading different types of targets by image capture. The arrangement includes a housing, an imaging assembly supported by the housing for capturing an image of a target over a field of view, and a controller for automatically distinguishing between the different types of targets. The controller is operative for decoding a symbol if the target being imaged is a symbol target, and for identifying and processing individual fields on a form if the target being imaged is a form target.

The controller is further operative for identifying a size and a location of each of the fields on the form target, and for processing each field by extracting and recognizing data in each field. The controller determines a size and location of the form target, and determines the size and the location of each field relative to those of the form target to identify which type of form target is being imaged. In a preferred embodiment, the imaging assembly advantageously includes a solid-state imager having an array of image sensors, preferably, a CCD or a CMOS array, and at least one imaging lens for focusing the captured image onto the array. A trigger or object sensing assembly is supported by the housing, for activating the reading. The controller is operative for automatically distinguishing between the different types of targets in response to activation by the trigger/object sensing assembly.

In accordance with another aspect of this invention, a method of electro-optically reading different types of targets, by image capture, is performed by capturing an image of a target over a field of view, automatically distinguishing between the different types of targets, decoding a symbol if the target being imaged is a symbol target, and identifying and processing individual fields on a form if the target being imaged is a form target

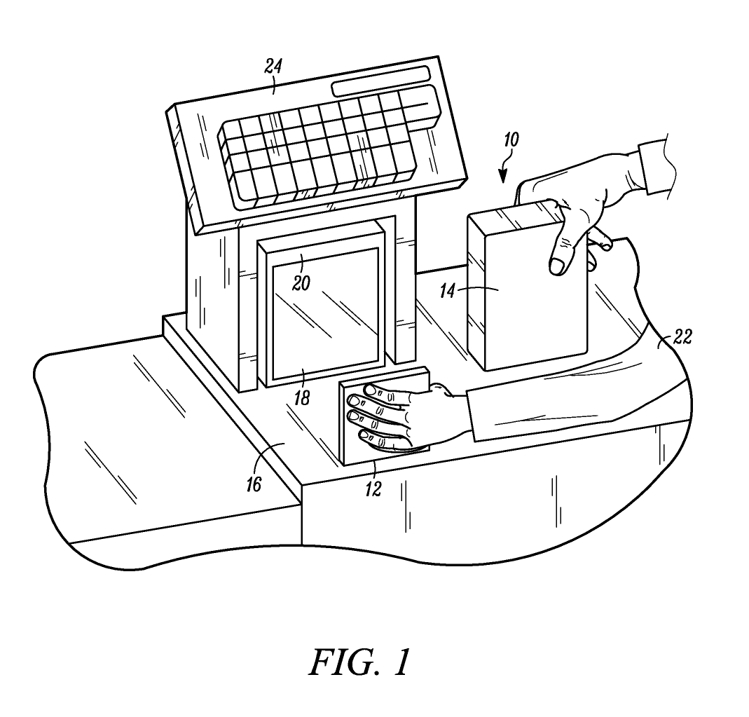

Reference numeral 10 in FIG. 1 generally identifies a workstation for processing transactions and specifically a checkout counter at a retail site at which targets, such as a form target 12, or a box bearing a symbol target 14, are processed. Each form target 12 is a document, label, receipt, signature, driver's license, identification badge, payment/loyalty card, etc., each bearing one or more data fields, typically containing alphanumeric characters, to be imaged. Some form targets may even include one or more one- and/or two-dimensional bar code symbols. Each symbol target 14 includes one or more one- and/or two-dimensional bar code symbols, each bearing elements, e.g., bars and spaces, of different widths and reflectivities, to be decoded.

The counter includes a countertop 16 across which the targets are slid at a swipe speed past, or presented to, a generally vertical or upright planar window 18 of a portable, box-shaped, vertical slot reader or imaging reader 20 mounted on the countertop 16. A checkout clerk or user 22 is located at one side of the countertop, and the imaging reader 20 is located at the opposite side. A host or cash/credit register 24 is located within easy reach of the user. The user 22 can also hold the imaging reader 20 in one's hand during imaging.

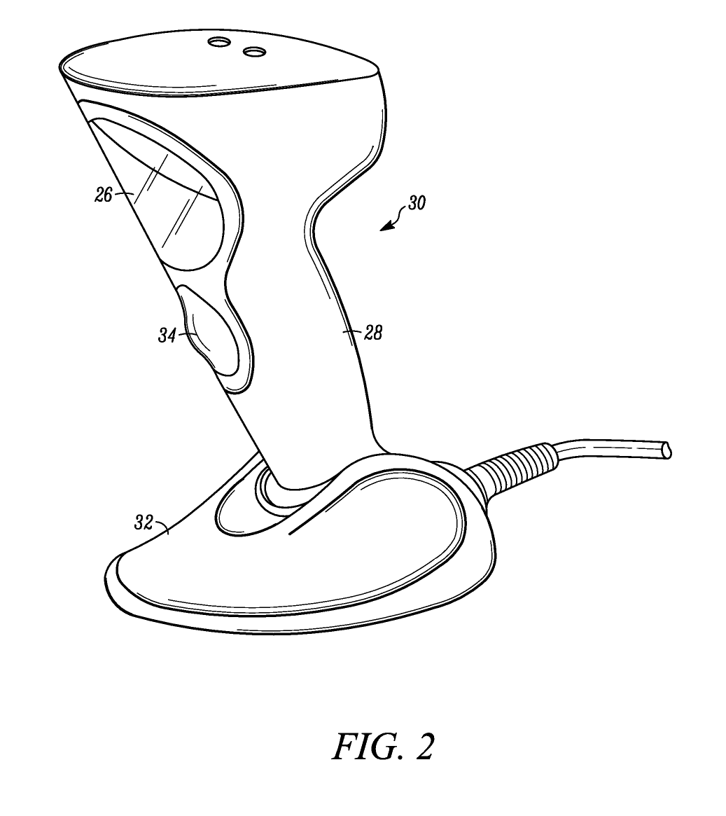

Reference numeral 30 in FIG. 2 generally identifies another imaging reader having a different configuration from that of imaging reader 20. Imaging reader 30 also has a generally vertical or upright window 26 and a gun-shaped housing 28 supported by a base 32 for supporting the imaging reader 30 on a countertop. The imaging reader 30 can thus be used as a stationary workstation in which targets are slid or swiped past, or presented to, the vertical window 26, or can be picked up off the countertop and held in the operator's hand and used as a handheld imaging reader in which a trigger 34 is manually depressed to initiate imaging of a target. In another variation, the base 32 can be omitted.

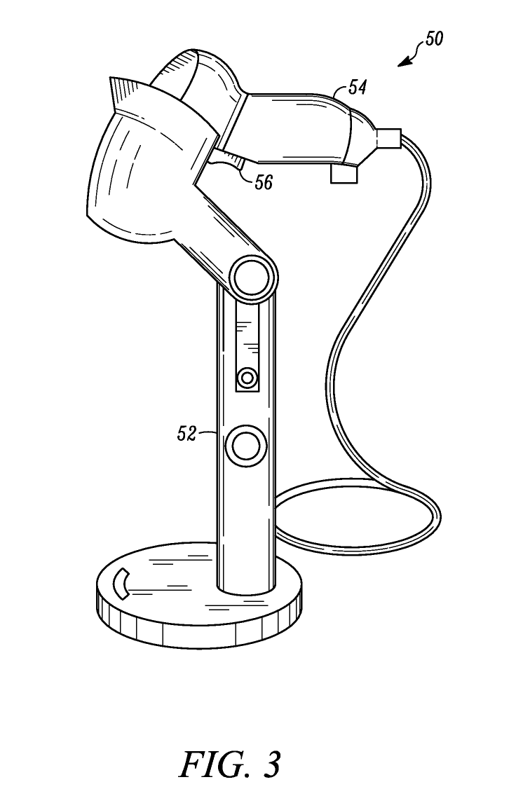

Reference numeral 50 in FIG. 3 generally identifies another portable, electro-optical imaging reader having yet another operational configuration from that of imaging readers 20, 30. Reader 50 has a window and a gun-shaped housing 54 and is shown supported in a workstation mode by a stand 52 on a countertop. The reader 50 can thus be used as a stationary workstation in which targets are slid or swiped past, or presented to, its window, or can be picked up off the stand and held in the operator's hand in a handheld mode and used as a handheld system in which a trigger 56 is manually depressed to initiate reading of the target.

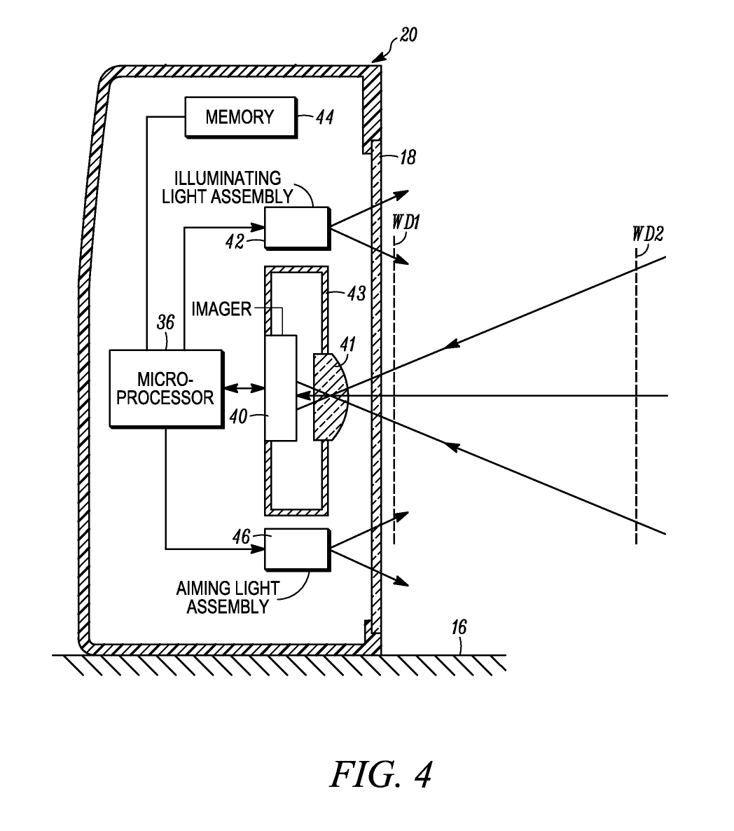

Each reader 20, 30, 50 includes, as shown for representative reader 20 in FIG. 4, an imaging assembly including an image sensor or imager 40 and at least one focusing lens 41 that are mounted in a chassis 43 mounted within a housing of the reader. The imager 40 is a solid-state device, for example, a CCD or a CMOS imager and has an area array of addressable image sensors or pixels operative for capturing light through the window 18 over a field of view from a target 12, 14 located at a target distance in a working range of distances, such as close-in working distance (WD1) and far-out working distance (WD2) relative to the window 18. In a preferred embodiment, WD1 is about one inch away from the focusing lens 41, and WD2 is about ten inches away from the focusing lens 41. Other numerical values for these distances are contemplated by this invention.

An illuminating light assembly 42 is optionally mounted in the housing of the imaging reader and preferably includes a plurality of illuminating light sources, e.g., light emitting diodes (LEDs) and illuminating lenses arranged to uniformly illuminate the target with illumination light. An aiming light assembly 46 is also optionally mounted in the housing and is operative for projecting an aiming light pattern or mark, such as a “crosshair” pattern, with aiming light from an aiming light source, e.g., an aiming laser or one or more LEDs, through aiming lenses on the target. The user aims the aiming pattern on the target to be imaged.

As shown in FIG. 4, the imager 40, the illuminating LEDs of the illuminating assembly 42, and the aiming light source of the aiming light assembly 46 are operatively connected to a controller or programmed microprocessor 36 operative for controlling the operation of these components. Preferably, the microprocessor 36 is the same as the one used for decoding a symbol if the target being imaged is a symbol target, and for identifying and processing individual fields on a form if the target being imaged is a form target. The microprocessor 36 is connected to an external memory 44.

In operation, the microprocessor 36 sends command signals to energize the aiming light source to project the aiming light pattern on the target, to energize the illuminating LEDs 42 for a short time period, say 500 microseconds or less to illuminate the target, and also to energize the imager 40 to collect light from the target only during said time period. A typical array needs about 11 to 33 milliseconds to acquire the entire target image and operates at a frame rate of about 30 to 90 frames per second. The array may have on the order of one million addressable image sensors.

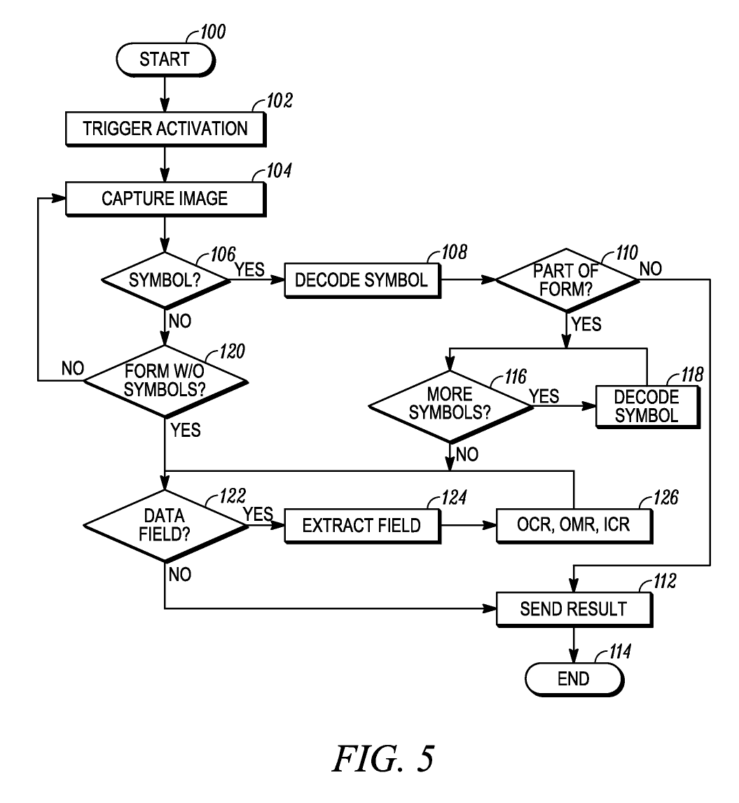

In accordance with one aspect of this invention, the microprocessor 36 is operative, for automatically distinguishing between the different types of targets 12, 14, for decoding a symbol if the target being imaged is a symbol target 14, and for identifying and processing individual fields on a form if the target being imaged is a form target 12. More specifically, turning to the operational flow chart of FIG. 5, a reading session begins at start step 100. Activation of reading is initiated by manually activating the trigger 34, 56 in step 102, or by automatic activation by an object sensing assembly. An image of the target is captured by the imager 40 under control of the microprocessor 36 in step 104.

The microprocessor 36 now analyzes the captured image. If the image contains a bar code symbol, as determined in step 106, then the microprocessor 36 will attempt to decode the symbol in step 108, and then determine if the symbol is part of a form in step 110. If the symbol is not part of a form, then the results of a successfully decoded symbol are sent to a host computer in step 112, and the reading session ends at step 114. If the microprocessor 36 determines that the symbol is part of a form in step 110, then the microprocessor 36 determines if there are any more symbols in step 116. If so, then each additional symbol is decoded in step 118.

If there are no more symbols determined in step 116, or if the microprocessor 36 determines, in step 120, that the image contains a form without any symbols, then the microprocessor 36, as explained in further detail below, looks for one or more data fields, as determined in step 122, in the captured image. If there are no data fields, then the results are sent to the host computer in step 112. If there are data fields, then the microprocessor 36, as explained in further detail below, will extract the data contained in each field in step 124, and then apply either optical character recognition (OCR), or optical mark recognition (OMR), or intelligent character recognition (ICR), as appropriate in step 126, to recognize the data contained in a respective field. It is possible that, for some fields, no post-processing is needed, or the only post-processing needed are image-based (such as brightening, sharpening, etc.), in which case, the data field is output as an image. This is the case for a photograph field and a signature field, for example. In these cases, control goes back directly to step 122.

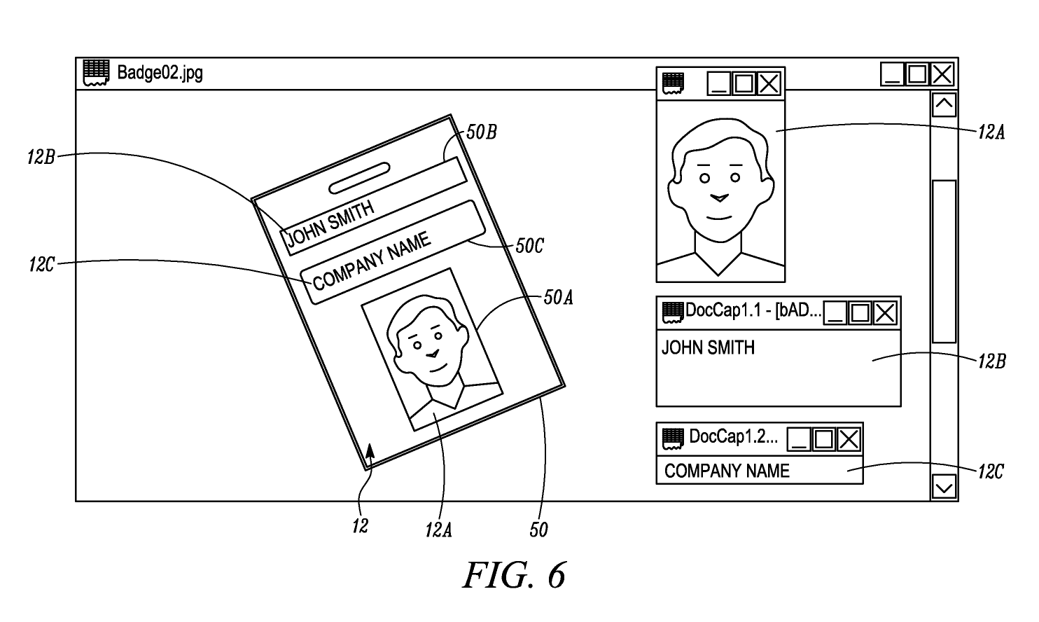

FIG. 6 is a screen shot to help explain how the microprocessor 36 recognizes a form and how the data contained in each field is extracted. In this example, the form target 12 is an employee badge having three data fields, and is displayed at the left side of the screen shot. Field 12A is an image of the employee. Field 12B is the name of the employee in alphabetic letters. Field 12C is the name of the employer in alphabetic letters. The microprocessor 36 analyzes the captured image of the employee badge and identifies the various fields by outlining them. Specifically, the microprocessor 36 outlines the entire badge by creating a quadrilateral 50 that surrounds the perimeter of the entire badge. The microprocessor 36 also outlines the field 12A by creating a cropped region or quadrilateral 50A that surrounds the perimeter of the field 12A, outlines the field 12B by creating a cropped region or quadrilateral 50B that surrounds the perimeter of the field 12B, and outlines the field 12C by creating a cropped region or quadrilateral 50C that surrounds the perimeter of the field 12C. The microprocessor 36 extracts the data from each of these cropped regions 50A, 50B, 50C, and they are individually displayed at the right side of the screen shot.

The microprocessor 36 can also be taught to recognize different type of forms. For example, the size and location of each cropped regions 50A, 50B, 50C relative to one another, as well as relative to the rectangle 50, can be loaded onto the microprocessor 36 during manufacture, or during initial setup, and then the microprocessor 36 will know, upon analysis of the captured image, exactly what form is being imaged. This process can be repeated for multiple forms. Thus, the reading of symbol targets as well as different form targets is streamlined. For each reader activation, the microprocessor 36 will automatically determine whether the target is a symbol or a form, and, if a form, the microprocessor 36 will determine which form is being imaged, and then extract and recognize the data in each field. The user need not switch modes during a reading session.

In the foregoing specification, specific embodiments have been described. However, one of ordinary skill in the art appreciates that various modifications and changes can be made without departing from the scope of the invention as set forth in the claims below. For example, the arrangement described herein is not intended to be limited to a stand-alone electro-optical reader, but could be implemented as an auxiliary system in other apparatus, such as a computer or mobile terminal. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for electro-optically reading different types of targets by image capture, comprising:
a housing;
an imaging assembly supported by the housing, for capturing an image of a target over a field of view; and
a controller for automatically distinguishing between the different types of targets, for decoding a symbol if the target being imaged is a symbol target, and for identifying and processing individual fields on a form if the target being imaged is a form target.

2. The arrangement of claim 1, wherein the housing has a handle for handheld operation, and a trigger supported by the handle for activating the reading.

3. The arrangement of claim 1, wherein the imaging assembly includes a solid-state imager having an array of image sensors, and an imaging lens for focusing the captured image onto the array.

4. The arrangement of claim 1, wherein the array is two-dimensional.

5. The arrangement of claim 1, and a trigger supported by the housing, for activating the reading, and wherein the controller is operative for automatically distinguishing between the different types of targets in response to activation by the trigger.

6. The arrangement of claim 1, wherein the controller is operative for identifying a size and a location of each of the fields on the form target, and for processing each field by extracting and recognizing data in each field.

7. The arrangement of claim 6, wherein the controller is operative for recognizing the data by applying one of optical character recognition (OCR), optical mark recognition (OMR), and intelligent character recognition (ICR).

8. The arrangement of claim 1, wherein the controller is operative for determining a size and location of the form target, and for determining the size and the location of each field relative to those of the form target to identify which type of form target is being imaged.

9. A method of electro-optically reading different types of targets by image capture, comprising:
capturing an image of a target over a field of view; and
automatically distinguishing between the different types of targets;
decoding a symbol if the target being imaged is a symbol target; and
identifying and processing individual fields on a form if the target being imaged is a form target.

10. The method of claim 9, wherein the capturing is performed by a solid-state imager having an array of image sensors, and focusing the captured image onto the array.

11. The method of claim 10, and configuring the array as a two-dimensional array.

12. The method of claim 9, and activating the reading by a trigger, and wherein the automatically distinguishing between the different types of targets is performed by in response to activation by the trigger.

13. The method of claim 12, and mounting the trigger on a housing, and wherein the trigger is activated while holding the housing in a user's hand.

14. The method of claim 9, and identifying a size and a location of each of the fields on the form target, and processing each field by extracting and recognizing data in each field.

15. The method of claim 14, wherein the recognizing the data is performed by applying one of optical character recognition (OCR), optical mark recognition (OMR), and intelligent character recognition (ICR).

16. The method of claim 9, and determining a size and location of the form target, and determining the size and the location of each field relative to those of the form target to identify which type of form target is being imaged.
